(19) United States
(12) Patent Application Publication
(10) Pub. No.: US 2003/0173130 A1
(43) Pub. Date: Sep. 18, 2003

(54) Mobile work platform

(76) Inventor: Michael W. Johns, Broadview Heights, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/386,319

(22) Filed: Mar. 11, 2003

Related U.S. Application Data
(60) Provisional application No. 60/363,368, filed on Mar. 11, 2002.

(51) Int. Cl. B60K 17/34

(52) U.S. Cl. 180/234

(57) ABSTRACT

A mobile work platform is provided which includes four independently controllable wheels. The wheel speed as well as the motion of other components on the platform may be remotely controlled via continuously supplied or pre-programmed communications, thus negating the need for any type of control tether. The steering of the wheels, drive speed as well as the motion of a turret, boom and other components may be precisely and repeatably controlled using a system including a computer, transceivers, antenna, control boards and controlled hydraulic pumps and/or valves. The mobile work platform is controllable at distances up to five miles in an environment including buildings or other obstructions and up to twenty miles with a clean line of sight.

### PRIORITY CLAIM

This application claims the benefit of U.S. provisional patent application No. 60/363,368 filed on Mar. 11, 2002 the entirety of which is hereby incorporated by reference.

### FIELD OF THE INVENTION

This invention generally relates to devices used in construction and demolition activities and more specifically remotely operable wheeled devices used in construction and demolition activities.

### BACKGROUND OF THE INVENTION

Mobile work platforms are popular for use in construction and demolition activities. Wheeled platforms have the benefit of being maneuverable. Platforms are used to support people and tools. Some typical types include scissor lifts and snorkel lifts. Often platforms include hydraulically operable arms which may have one or more tools attached to the end thereof. Common attachments include buckets, hydraulic clamps, saws, etc. Remotely controllable platforms are beneficial for work in hazardous environments where personal access is limited. Existing remotely controllable platforms are limited in that they utilize a tether or have an untethered operational distance between the platform and controls which does not exceed 243 meters (800 feet).

Another drawback to existing work platforms is their lack of maneuverability. Most platforms include wheels which are interconnected or a combination of steerable and non-steerable wheels. This results in a platform which is not as effectively controllable as may be desired in certain circumstances. These platforms are less useful in areas with multiple obstacles. Alternatively, these platforms with less controllable wheels are designed smaller than is desirable in order to gain maneuverability. However with a smaller size, a platform is not able to support the longer or larger tools which can be supported by a larger platform.

In addition to general maneuverability, the ability to position the attachments at the end of a control arm is often limited to a minimum number of axes of movement on existing platforms. What is desired is a heavy duty platform which is highly maneuverable, includes arms which can be positioned as desired, and is accurately controllable at extended distances.

### BRIEF SUMMARY OF THE INVENTION

The mobile work platform of the present invention provides an improved device for use in all environments, including hazardous environments. The work platform includes four wheel independent steering with superior control.

The mobile work platform of the present invention includes superior remote operational characteristics. The mobile work platform may be controlled accurately, without a tether, when the platform is located up to 8 kilometers (5 miles) away from the controls in a “city” environment (i.e. including buildings or other large obstacles). Using a clear line of sight, this distance is increased to a range of 32.2 kilometers (20 miles). The wheels as well as other components on the platform may be remotely controlled via continuously supplied or preprogrammed communications from remote controls, thus negating the need for any type of control tether. The steering of the wheels, drive speed as well as the motion of a turret, boom assembly and other components may be precisely and repeatably controlled.

In a first embodiment of the invention a remotely controllable work platform particularly suited for use in hazardous environments is provided which includes a drivable chassis including four independently steerable wheels, a boom assembly supported by the chassis, first and second manipulator arms supported by the boom assembly and controls remotely located from said chassis.

In another embodiment of the invention a remotely controllable work platform particularly suited for use in hazardous environments is provided which includes a drivable chassis, a boom assembly supported by the chassis, first and second manipulator arms supported by the boom assembly wherein each manipulator arm may be rotated about at least five independent axes of rotation, and controls remotely located from said chassis. These and other features, aspects and advantages of the present invention will become better understood with regard to the following description, appended claims, and accompanying drawings.

### BRIEF DESCRIPTION OF THE FIGURES

FIG. 1 is perspective view of the mobile work platform;

FIG. 2 is a perspective close up view of the wheel assembly;

FIG. 3 is a perspective view of the mobile work platform without the boom or manipulator arms attached;

FIG. 4 is a side view of the mobile work platform;

FIG. 5 is a perspective view of a manipulator arm;

FIG. 6 is a front view schematic diagram of the mobile work platform showing the boom and manipulator arms in a fully contracted and fully extended position;

FIG. 7 is a side view schematic diagram of the mobile work platform showing the boom and manipulator arms in a fully contracted and fully extended position; and

FIG. 8 is a side view of the mobile work platform with a tool attached.

### DETAILED DESCRIPTION OF PREFERRED AND ALTERNATE EMBODIMENTS OF THE INVENTION

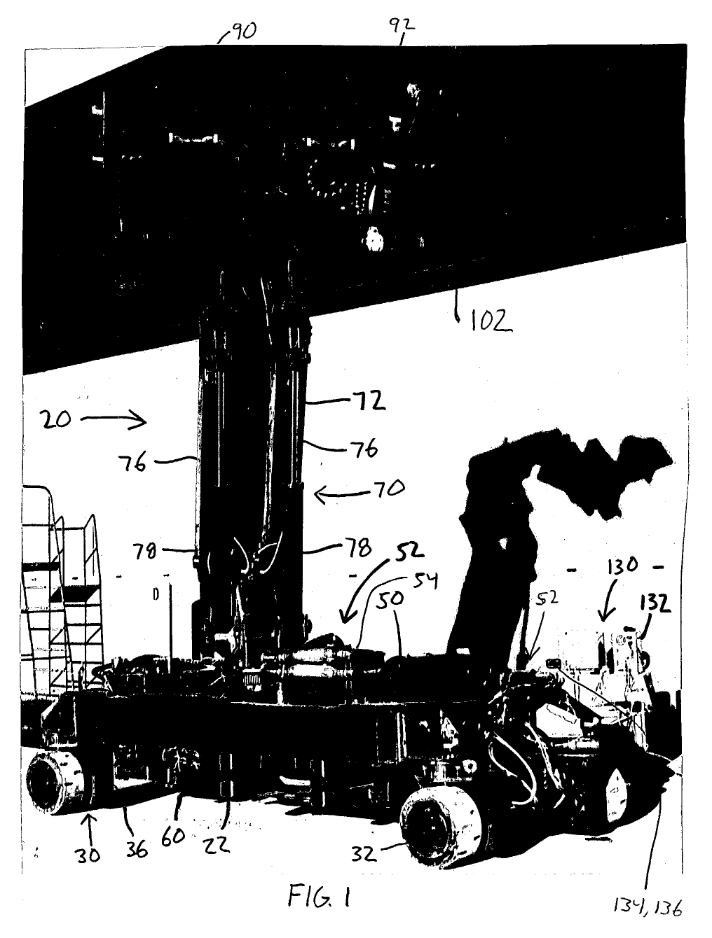

Referring to FIG. 1, a remotely controllable mobile work platform 20 is provided particularly suited for use in hazardous environments. The work platform 20, as described in more detail below includes a four wheeled chassis 22 with independently steerable wheels 32, two manipulator arms 90 and 92 and platform controls 130 which can effectively manipulate the work platform 20 from up to eight kilometers (five miles) away in a “city” environment, which includes obstructions, or up to 32.2 kilometers (20 miles) away with a clear line of sight.

The chassis 22 acts as a support for an engine 50, hydraulic components 52, and a boom assembly 70. The chassis 22 is in turn supported by four wheels 32 which are independently steerable as described in more detail below. The chassis 22 may be any shape but is preferably rectangular. The chassis 22 in a preferred embodiment has dimensions of approximately 3.9 meters (12 feet, 10 inches) by 1.65 meters (5 feet, 5 inches). The chassis 22 may be formed of steel beams, channel members and/or tubes. The chassis 22 may be an open framework, having cross beams only where necessary for the support of one or more structures. Alternatively, the chassis 22 may include a floor covering areas not covered by the beams, etc. Preferably the chassis 22 has a level orientation, but will remain functional if the work platform 20 is being operated on an incline.

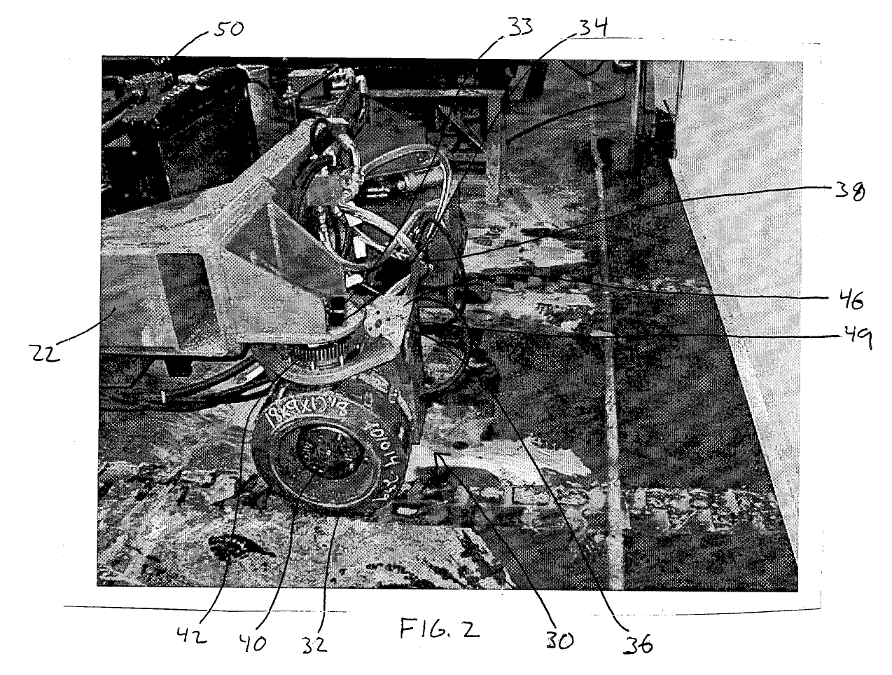

The chassis 22 is supported by four wheels 32. The wheels 32 are independently steerable as described below. Referring to FIG. 2, each wheel 32 is part of a wheel assembly 30 which also includes a wheel bracket 36, motor 38, torque hub 40 and slew drive 42. The wheel 32 may be any type, but is preferably a polyurethane tire pressed on a wheel rim, each wheel 32 having a diameter of approximately 45.7 centimeters (18 inches) and at least a 4523 kilogram (10,000 pound) rating. Each wheel 32 is supported on a torque hub 40. A preferred torque hub 40 is model MW38DF0330 manufactured by Fairfield. The torque hub 40 is attached to the wheel bracket 36 and the torque hub 40 is driven by a hydraulic motor 38. The motor may be controlled as described below. In a preferred embodiment, the motor 38 is a two speed hydraulic motor manufactured by Sundstrand. The wheel bracket 36 includes both a vertical plate 44 and horizontal plate 46, the horizontal plate 46 located above and attached to the vertical plate 44. The torque hub 40 and motor 38 are attached to the vertical plate 44 of the wheel bracket 36. The slew drive 42 is attached to the horizontal plate 46 of the wheel bracket 36 and the chassis 22. The slew drive 42 allows the wheel bracket 36 to be rotated about a vertical axis through 180 degrees of motion, thus, allowing steering of the wheel 32. The slew drive 42 is driven by hydraulic fluid and is controlled. In a preferred embodiment, the slew drive 42 is model S7-73-2-R manufactured by Kinematics.

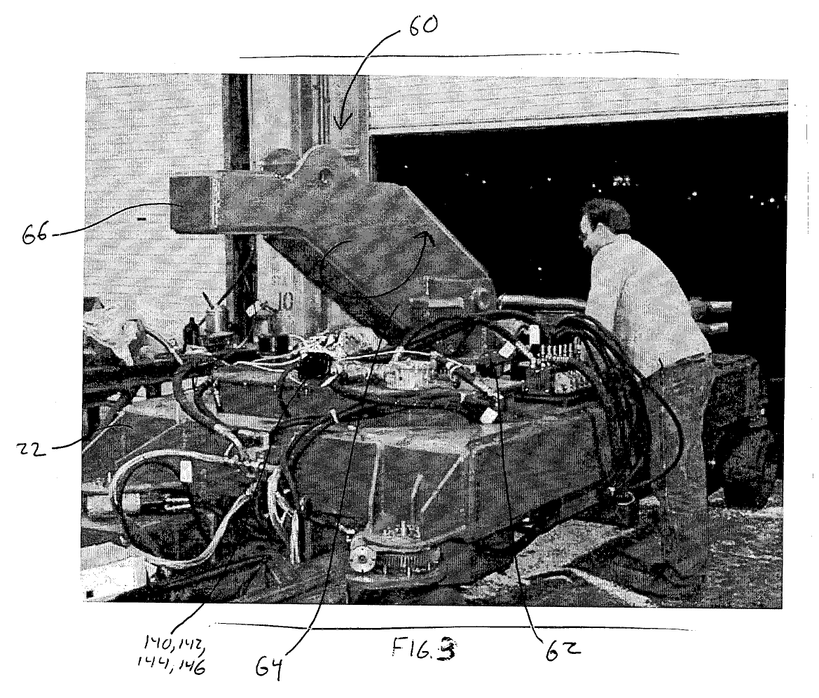

Referring to FIGS. 2 and 3, each wheel 32 may be steered through an encoded wheel drive system. A vertical steering shaft 33 extends through the horizontal plate of the wheel bracket. A positional reader 34 is attached adjacent to the steering shaft 33 and reads the position of the shaft 33 relative to the positional reader 34 which is stationary. The positional reader 34 sends electronic information to a control board 144 mounted upon the chassis 22. The positional information is sampled from the control board 144 by the remotely located control computer 132 as described in more detail below. New positioning directions may be transferred from the remotely located control computer 132 back to the control board 144 upon the chassis 22. This information is then transferred from the control board 144 to an electrically controlled hydraulic valve or pump. The valve or pump may be controlled numerically or using pulsed hydraulic control. The communication from the control board 144 may be converted, if necessary, to an appropriate voltage for the hydraulic valve or pump using an integrated signal board. The hydraulic valve controls the hydraulic fluid supplied to the slew drive 42. The encoded wheel drive system allows the wheels 32 to be rotated to a specific position in a specific amount of time. This system provides both precision and repeatability in the manner of control.

In a similar manner all of the slew drives attached to rotational joints on any part of the mobile work platform 20 may be controlled.

The speed of rotation of the wheels 32 may also be controlled independently or in unison. Each hydraulic motor 38 includes a speed sensor which generates an electrical communication. This communication may be transferred to the remotely located controls 130 as described below and similarly, instructional communications from the remotely located controls 130 may be received and directed to the hydraulic motor 38.

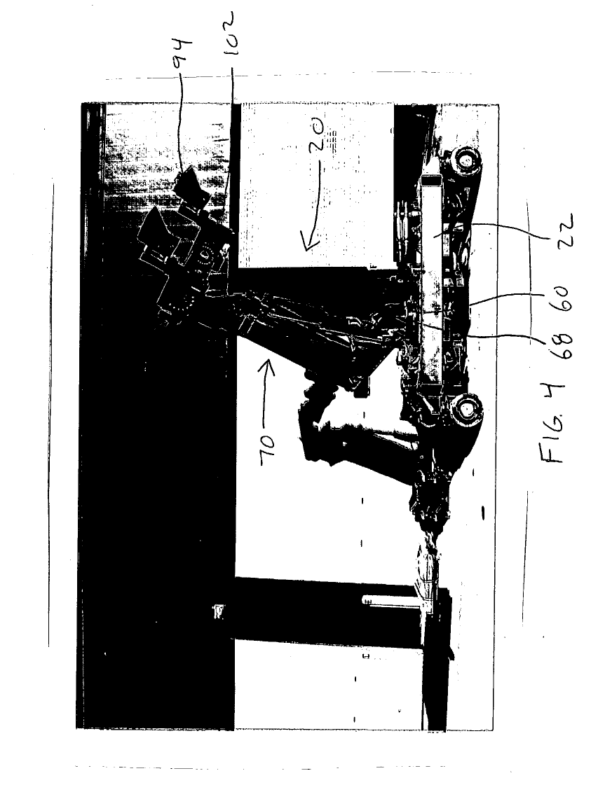

Referring to FIG. 3 and 4, the chassis 22 supports a turret 60 which in turn supports a boom assembly 70. The turret 60 includes a circular base 62 oriented horizontally and a diagonally extending raised section 64 which has an extending finger 66 at its distal end. The finger 66 and one or more apertures in the raised section 64 are used for attachment to the boom assembly 70. The turret 60 may be rotated with respect to the chassis 22 around a vertical axis through 180 degrees of rotation, left or right. The turret 60 is driven by a slew drive 68 which is separate and apart from the slew drives used on the wheels. In a preferred embodiment of the invention, the turret slew drive 68 is model S17-102-12-R manufactured by Kinematics. The turret base 62, raised section 64, and extending finger 66 may be made from steel. The turret 60 provides a means for rotating the boom assembly 70 and the manipulator arms 90 and 92 attached thereto. The turret 60 defines a first axis of rotation for the manipulator arms 90 and 92.

Referring back to FIG. 1, the boom assembly 70 is a raisable member, with respect to the chassis 22, which acts as a connection between the turret 60 of the chassis 22 and the manipulator arms 90 and 92. The boom assembly 70 includes a main section 72 and an upper section 74. The sections may be manufactured in varying sizes. The boom assembly 70 may be extendable. The main section 72 and upper section 74 are connected at a rotational joint. The main section 72 comprises two beams 76. Each beam 76 is attached at a pivot point on its first end to the turret 60 and at an opposite end to one end of a hydraulic cylinder 78. The opposite end of each hydraulic cylinder 78 is attached to the turret 60. The boom assembly 70 is raised and lowered by the expansion of the two hydraulic cylinders 78. The beams 76 may work in tandem or may be separated and operated independently. The raisable boom assembly 70 defines a second axis of rotation for the manipulator arms 90 and 92. The cylinders 78 may have differing stroke lengths. The boom assembly 70 also includes a slew drive 80 at its rotational joint between the main section 72 and the upper section 74. In a preferred embodiment of the invention, the slew drive 80 is model S17-102-12-R manufactured by Kinematics. The rotational joint and slew drive 80 allow rotation of the upper section 74 of the boom assembly 70 with respect to the main section 72 which defines a third axis of rotation for positioning the manipulator arms 90 and 92. At full extension the upper section 74 of the boom assembly 70 at its peak is at least 11 meters (36 feet) off the ground. The upper section 74 of the boom assembly 70 supports and provides a point of attachment for the first and second manipulator arms 90 and 92. The upper section 74 has a tee shape providing attachment points for the main section 72 of the boom assembly 70 and both manipulator arms 90 and 92.

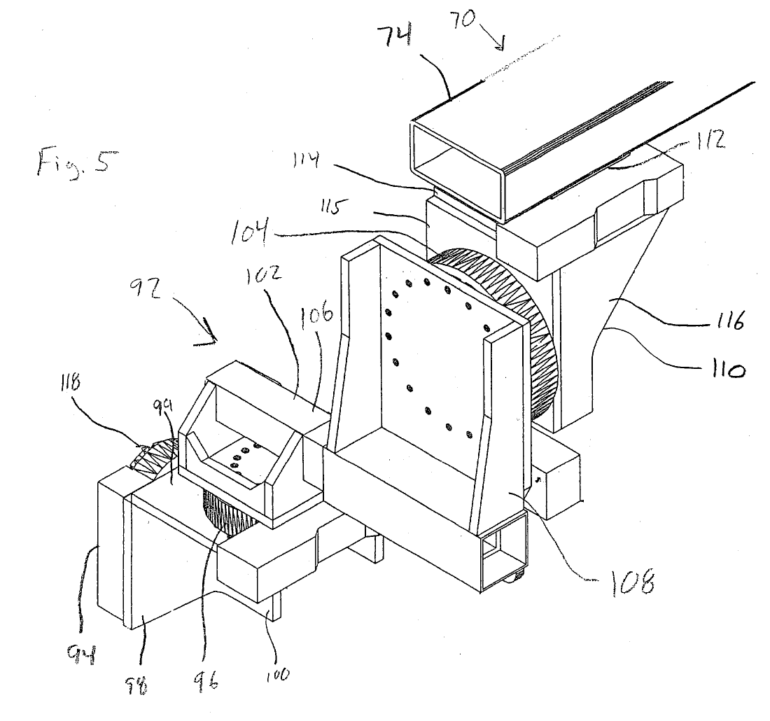

Referring to FIGS. 4 and 5, the mobile work platform 20 includes two manipulator anus 90 and 92. Each arm has a lift capacity of at least 1134 kilograms (2500 pounds). The arms 90 and 92 each include three sections: a cutter/gripper attachment section 94, mid-section 102 and boom transition section 110. There are three rotational joints associated with each arm. The first is between the cutter/gripper attachment section 94 and the mid section 102, the second between the mid-section 102 and boom transition section 110, and the third between the boom transition section 110 and the upper section 74 of the boom assembly 70. Each rotational joint has a slew drive 96, 104, 112 attached adjacent to the joint to facilitate rotational movement. These three rotational joints define the fourth, fifth and sixth axes of rotation for the manipulator arms 90 and 92

The cutter/gripper attachment section 94 may include a top plate 98, back plate 99 and one or more side plates 100. The cutter/gripper attachment section 94 functions as a connection point for a hydraulically powered tool 120 (see FIG. 8) selected from a group including: gripper heads, saws, bucket systems, lifting forks, cutting heads, high pressure water cutting and scabling devices, detection systems, gripping heats, or vacuum systems. An adapter plate (not shown) may be fabricated for each hydraulically powered tool 120 to be attached to the arm 90 and 92. Alternatively or in addition, electrically powered and/or controlled tool may be used. All hydraulic and electric cords may pass through the center of the adapter plate. The adapter plate is shaped consistently for each tool to allow attachment to the connecter/gripper attachment section 94 of the arm 90 and 92. An attachment slew drive 118 is connected to the cutter/gripper attachment section 94 to assist in connecting the adapter plate. The mid-section may 102 include two members 106 and 108 attached in a suitably shaped configuration. A rotational joint is at the end of each member 106 and 108. The boom transition 110 may include a top plate 114, back plate 115 and one or more side plates 116 in a manner similar to the cutter gripper attachment section 94.

Referring to FIGS. 1 and 3, the mobile work platform 20 includes a group of controls 130 located remotely from the chassis 22. The controls 130 are independent from the chassis meaning that they are untethered, not physically connected to the chassis 22. These controls 130 include a computer 132 which may be programmed to allow a user to efficiently communicate directional instructions to the platform 20 and receive information regarding the position of the platform 20 and the components thereon. In a preferred embodiment of the invention a D.O.S. based control program is installed on the computer. In other embodiments the control program may be supported by different operating systems. The controls 130 also include a group of antennas 134 for sending information to and receiving information from the work platform 20. The antennas may be a directional type such as a Yagi 902-928 MHz 10 db 7 element antenna. Also included in the remotely located controls 130 are transceivers 136 which send information from the computer 132 and can sample information from similar, if not identical transceivers 142 on the chassis 22, which are part of the chassis controls 140. The transceivers 142 on the chassis are placed inside enclosures for protection. In a preferred embodiment, each transceiver on the chassis or remotely located is rated at 902-928 MHz, 115 Kbaud and 12 volts. The transceivers 142 on the chassis 22 are powered by 12 volt batteries mounted on the chassis 22. A chassis control board 144 is located along with the transceivers 142 as part of the chassis controls 140 upon the rear of the chassis 22. The control board 144 takes information from the controls 130 and modifies it as necessary and sends it to the individual components on the platform 20 in a manner similar to the control of the wheels 32 described above. Upon the chassis 22, an antenna 146 is associated with each transceiver, in a preferred embodiment of the invention an omnidirectional antenna 902-928 MHz, 115 Kbaud Spread Spectrum wireless data type.

The control board 144 on the chassis 22 communicates with the remotely located control computer 132 using any of the following techniques: a signal of any wavelength including radio waves and microwaves. This communication can also be referred to as a control signal or control command. Information from the control board 144 on the chassis 22 may be sampled up to 100 times per second by the remotely located control computer 132. In a similar manner, information from the remotely located control computer 132 may be sent to the control board 144 on the chassis 22. Again the information from the remote controls 130 may be sampled up to 100 times per second. It should be understood that the control devices and systems of the present application, for example controls 130 as well as individual component controls, either alone or in combination, such as the control board 144 on the chassis 22, hydraulic valves, motors or pumps associated with the slew drives may use either conventionally known and available numerical or pulsed hydraulic control techniques.

A software control program may be on the computer 132 as part of the remotely located controls 130. The control program may be used to generate an execution sequence, a preprogrammed series of robotic steps for the mobile work platform 20 to perform or the program may be used to simply to accept and send the continuously inputted directions of a user. The control program and the control system described above provide a mobile work platform 20 which may be moved to any position, kept in place at any position, moved to any new position, wherein all previous positions and the time spent in any previous positions may be remembered and recalled for review or repetition. The control program and control system also allows a user to control the speed in which movement of components are made upon the mobile work platform 20. The control program and control system allow a user to obtain feed back on where the mobile work platform 20 is positioned presently, or obtain a history of positions the mobile work platform 20 has been in, or to add to or review pre-programmed positions to which the mobile work platform 20 will be moving. Any execution sequence may be repeated as desired and such reexecutions may be identical to the original executions mode by the mobile work platform 20.

Referring to FIG. 1, an engine 50 is supported upon the chassis 22 of the mobile work platform 20. In a preferred embodiment of the invention, the engine 50 is a Ford 7.5 liter v-8 cyl. complete open LPG power unit. The chassis 22 also supports a fuel tank for the engine 50. The engine 50 functions to drive a hydraulic pump 54, one of the hydraulic components 52 of the mobile work platform 52. In a preferred embodiment of the invention the hydraulic pump 54 is manufactured by Sundstrand. The hydraulic pump 54 is also supported by the chassis 22 and functions to move hydraulic fluid to all of the hydraulic driven components of the work platform except the motors 38 upon the wheel assemblies 30 which are supplied by a separate pump. Hydraulic fluid is stored in a reservoir and pumped through tubing or hoses to components as required, all considered hydraulic components 52 of the mobile work platform.

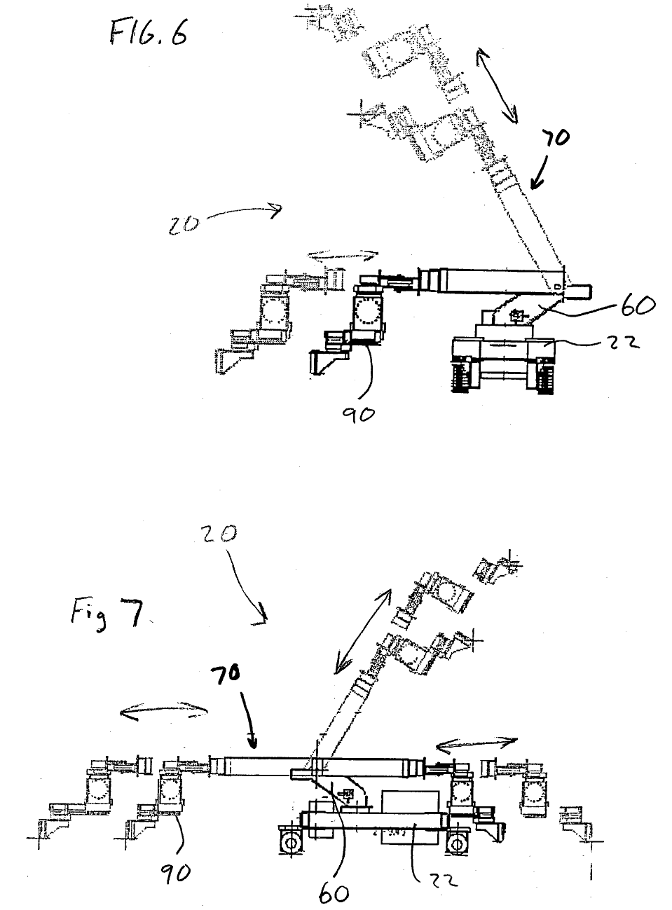

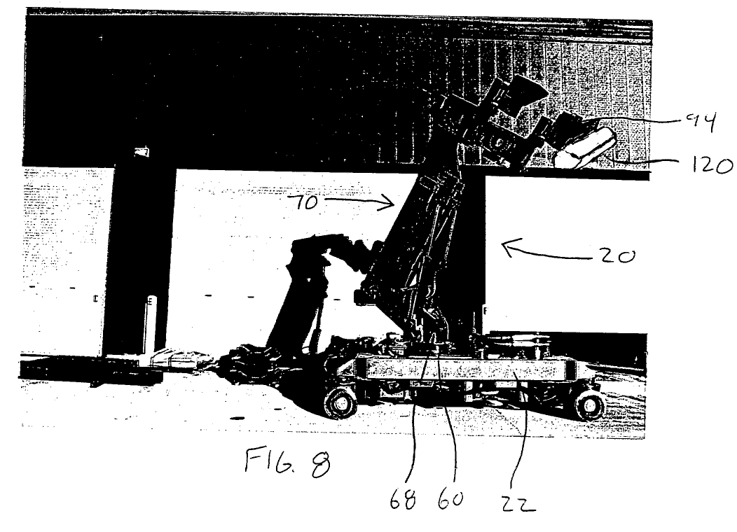

Referring to FIGS. 6 and 7, the range of motion of the boom assembly and manipulators arms is shown. The boom assembly 70 is extendable to provide an adjustable reach for the manipulator arms 90 and 92. In the embodiment shown with a rectangular chassis 22 with length exceeding width, the manipulator arm 90 may be extended to extreme positions both parallel and perpendicular to an axis along the length of the chassis 22. The boom assembly 70 may be fully extended such that the distance from the point where the boom assembly 70 attaches to the turret 60 to the end of the cutter/grabber attachment section of the manipulator arm 70 is approximately 6.1 meters (20 feet) along an axis parallel to the chassis length. The boom assembly 70 may be fully extended in a perpendicular direction as shown in FIG. 7 such that the distance from the centerline of the chassis 22 to the end of the cutter/grabber attachment section of the manipulator arm 70 is approximately 4.65 meters (15¼) feet.

One or more counterweights or outriggers (not shown) may be required to balance the work platform when fully extended in a lateral direction.

Attached hereto as Attachment 1 is the original provisional applications as described above.

Although the invention has been shown and described with reference to certain preferred and alternate embodiments, the invention is not limited to these specific embodiments. Minor variations and insubstantial differences in the various combinations of materials and methods of application may occur to those of ordinary skill in the art while remaining within the scope of the invention as claimed and equivalents. Use of the term “or” herein is the inclusive, and not the exclusive use.

1. A remotely controllable work platform comprising:
a drivable chassis including four independently steerable wheels;
a boom assembly supported by said chassis;
first and second manipulator arms supported by said boom assembly; and
controls remotely located from said chassis.

2. The controllable work platform of claim 1 wherein the speed of rotation of said four wheels is independently controllable.

3. The remotely controllable work platform of claim 1 wherein said four independently steerable wheels include encoded wheel drive systems.

4. The remotely controllable work platform of claim 1 wherein said boom assembly between said chassis and said first and second manipulator arms has the freedom to rotate 180 degrees with respect to said chassis.

5. The remotely controllable work platform of claim 1 wherein said controls remotely located from said chassis include a computer and a controller program.

6. The remotely controllable work platform of claim 1 wherein said manipulator arms are connectable to hydraulically powered tools.

7. A remotely controllable work platform comprising:
a drivable chassis;
a boom assembly supported by said chassis;
first and second manipulator arms supported by said boom assembly wherein each manipulator arm may be rotated about at least five independent axes of rotation; and
controls remotely located from said chassis.

8. The remotely controllable work platform of claim 7 wherein said boom assembly between said chassis and said first and second manipulator arms has the freedom to rotate 180 degrees with respect to said chassis defining a first axis of rotation for said manipulator arms.

9. The remotely controllable work platform of claim 8 wherein said boom assembly includes a main section and an upper section connected at a rotational joint defining a second axis of rotation for said manipulator arms.

10. The remotely controllable work platform of claim 9 wherein said boom assembly is raisable with respect to said chassis defining a third axis of rotation for said manipulator arms.

11. The remotely controllable work platform of claim 10 wherein each of said manipulator arms includes a cutter/gripper attachment section rotationally connected to a mid section rotationally connected to a boom transition section rotationally connected to said upper section of said boom assembly, said rotational connections together defining a fourth, fifth and sixth axes of rotation for said manipulator arms.

12. The remotely controllable work platform of claim 7 wherein each manipulator arm may be rotated about six independent axes of rotation.

13. A remotely controllable work platform comprising:
a drivable chassis supporting a boom assembly and at least one manipulator arm;
controls remotely located from and independent from said chassis;
chassis controls upon said chassis for controlling the means for steering said chassis;
wherein said controls remotely located from said chassis send a communication to said chassis controls for controlling said work platform.

14. The remotely controllable work platform of claim 13 wherein said controls remotely located from said chassis control said chassis up to a distance of approximately five miles from said chassis in a city environment.

15. The remotely controllable work platform of claim 13 wherein said controls remotely located from said chassis control said chassis up to a distance of approximately twenty miles in a clear line of sight.

16. The remotely controllable work platform of claim 13 wherein said controls remotely located from said chassis include a personal computer running a controller program whereby an execution sequence may be programmed for execution by the mobile work platform.

17. The remotely controllable work platform of claim 16 wherein said execution of an execution sequence may be repeated as desired by an operator and such reexecutions by the mobile work platform are identical to the original execution by the mobile work platform.

18. A remotely controllable work platform particularly suited for use in hazardous environments comprising:
a drivable chassis including four independently steerable wheels;
a boom assembly supported by said chassis;
first and second manipulator arms supported by said boom assembly; and
controls remotely located from said chassis.
